(19) United States
(12) Patent Application Publication
(10) Pub. No.: US 2019/0023281 A1
(43) Pub. Date: Jan. 24, 2019

(54) VEHICLE CONTROL DEVICE AND VEHICLE CONTROL METHOD

(71) Applicant: MITSUBISHI ELECTRIC CORPORATION, Tokyo (JP)

(72) Inventors: Shinsaku FUKUTAKA, Tokyo (JP); Reiko SAKATA, Tokyo (JP); Akiko IMAISHI, Tokyo (JP)

(73) Assignee: Mitsubishi Electric Corporation, Tokyo (JP)

(21) Appl. No.: 16/070,747

(22) PCT Filed: Feb. 12, 2016
(86) PCT No.: PCT/JP2016/054146

§ 371 Date: Jul. 17, 2018

(51) Int. Cl. B60W 50/14; B60Q 9/00; B60W 10/20; B60W 30/12; B60W 40/04; B60W 20/11

(52) U.S. Cl. CPC B60W 50/14; B60Q 9/008; B60W 10/20; B60W 30/12; B60W 2550/308; B60W 20/11; B60W 2050/146; B60W 2420/42; B60W 40/04

(57) ABSTRACT

Provided is a vehicle control device for controlling the motion of a vehicle, the device including: an operation detecting unit for detecting an operation on a vehicle; an information presenting unit for presenting pre-notification information for pre-notifying the motion accompanying the operation detected by the operation detecting unit to the outside of the vehicle; and a motion control unit for controlling the motion accompanying the operation detected by the operation detecting unit. This allows for preventing occurrence of a dangerous situation.

### TECHNICAL FIELD

The present invention relates to a vehicle control device and a vehicle control method for controlling the motion of a vehicle.

### BACKGROUND ART

Patent Literature 1 below discloses a vehicle control device for evaluating the risk of a vehicle and notifying a driver of a dangerous situation when there is a high risk.

### CITATION LIST

### Patent Literatures

Patent Literature 1: JP 2005-056372 A

### SUMMARY OF INVENTION

### Technical Problem

Since conventional vehicle control devices are configured as described above, when there is a risk that a host vehicle and another vehicle may be brought into contact with each other, a driver of the host vehicle can be notified that there is a risk of contact. However, there is a problem that a driver of the other vehicle cannot be informed of the risk of contact and that there are cases where it is difficult for the driver of the other vehicle to perform an operation to avoid the risk.

The present invention has been devised in order to solve the aforementioned problem, and it is an object of the present invention to provide a vehicle control device and a vehicle control method capable of preventing occurrence of a dangerous situation.

### Solution to Problem

A vehicle control device according to the present invention includes: an operation detecting unit for detecting an operation on a vehicle; an information presenting unit for presenting pre-notification information for pre-notifying motion accompanying the operation detected by the operation detecting unit to an outside of the vehicle; and a motion control unit for controlling the motion accompanying the operation detected by the operation detecting unit.

### Advantageous Effects of Invention

According to the present invention, since an information presenting unit presents pre-notification information for pre-notifying motion accompanying an operation detected by the operation detecting unit to the outside of the vehicle, and the motion control unit controls the motion accompanying the operation detected by the operation detecting unit, there is an effect that occurrence of a dangerous situation can be prevented.

### BRIEF DESCRIPTION OF DRAWINGS

FIG. 1 is a configuration diagram illustrating a vehicle control device according to a first embodiment of the present invention.

FIG. 2 is a diagram illustrating a hardware configuration of the vehicle control device according to the first embodiment of the present invention.

FIG. 3 is a diagram illustrating a hardware configuration of a computer in the case where the vehicle control device is implemented by software, firmware, and the like.

FIG. 4 is a flowchart illustrating a vehicle control method which is a processing procedure of the vehicle control device according to the first embodiment of the present invention.

FIG. 5A is an explanatory diagram illustrating an example of display data of pre-notification information for pre-notifying that a door opens, FIG. 5B is an explanatory diagram illustrating an example of display data of pre-notification information for pre-notifying turning left or right, FIG. 5C is an explanatory diagram illustrating an example of display data of pre-notification information for pre-notifying a start, and FIG. 5D is an explanatory diagram illustrating an example of display data of pre-notification information for informing an intention of giving way.

FIG. 6 is an explanatory diagram illustrating an example of control in the case where operation on a vehicle is “door opening operation”.

FIG. 7 is a configuration diagram illustrating a vehicle control device according to a second embodiment of the present invention.

FIG. 8 is a diagram illustrating a hardware configuration of the vehicle control device according to the second embodiment of the present invention.

FIG. 9 is a flowchart illustrating a vehicle control method which is a processing procedure of the vehicle control device according to the second embodiment of the present invention.

FIG. 10 is an explanatory diagram illustrating a display example of caution information by an information presenting unit 11.

FIG. 11 is a configuration diagram illustrating a vehicle control device according to a third embodiment of the present invention.

FIG. 12 is a diagram illustrating a hardware configuration of the vehicle control device according to the third embodiment of the present invention.

FIG. 13 is an explanatory diagram illustrating an example of pre-notification information corresponding to a relative state.

FIG. 14 is an explanatory diagram illustrating an example of motion control corresponding to a relative state.

FIG. 15 is an explanatory diagram illustrating a relationship between risk and relative states.

FIG. 16 is an explanatory diagram illustrating a relationship between risk and relative states.

FIG. 17A is an explanatory diagram illustrating an example in which a medium on which pre-notification information is displayed is the body of a vehicle, FIG. 17B is an explanatory diagram illustrating an example in which a medium on which pre-notification information is displayed is a window of a vehicle, FIG. 17C is an explanatory diagram illustrating an example in which a medium on which pre-notification information is displayed is a display device including a plurality of light emitting elements, and FIG. 17D is an explanatory diagram illustrating an example in which a medium on which pre-notification information is displayed is a display attached to the body of a vehicle.

### DESCRIPTION OF EMBODIMENTS

To describe the present invention further in detail, embodiments for carrying out the present invention will be described below with reference to the accompanying drawings.

### First Embodiment

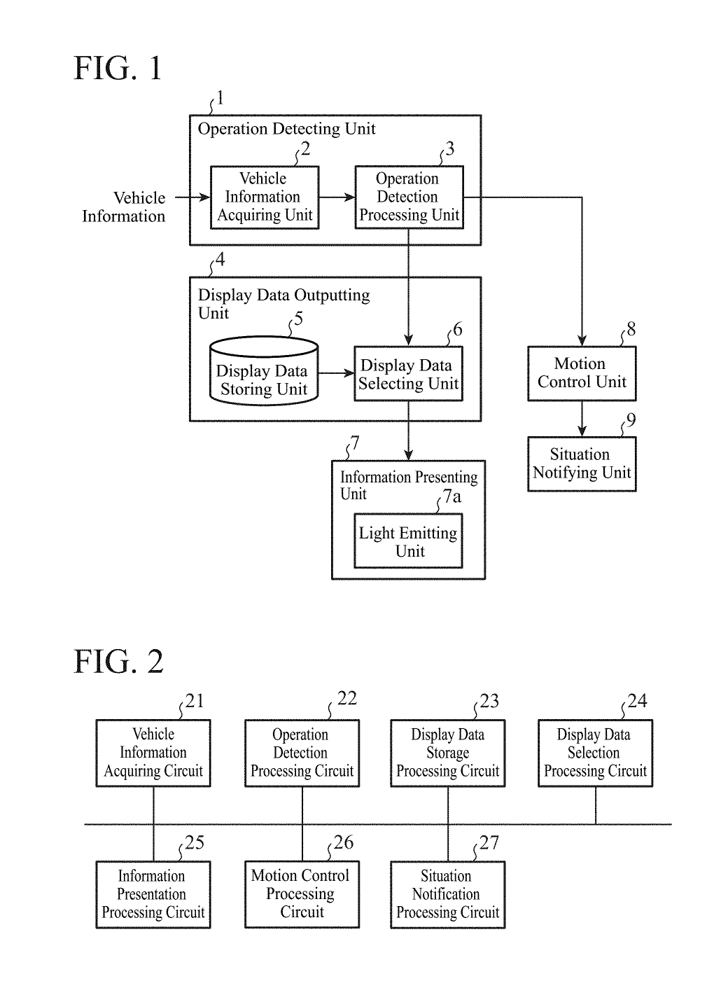

FIG. 1 is a diagram illustrating a configuration of a vehicle control device according to a first embodiment of the present invention. FIG. 2 is a diagram illustrating a hardware configuration of the vehicle control device according to the first embodiment of the present invention.

In FIG. 1, an operation detecting unit 1 includes a vehicle information acquiring unit 2 and an operation detection processing unit 3 and performs processing of detecting an operation on a vehicle.

The vehicle information acquiring unit 2 is implemented by a vehicle information acquiring circuit 21 illustrated in FIG. 2 including an interface device for an in-vehicle network such as a controller area network (CAN) and implements processing for acquiring vehicle information indicating the state of the vehicle from an onboard device through the in-vehicle network.

As vehicle information, for example, in addition to CAN data including operation information of an indicator, a steering wheel, an accelerator, a brake, a shift lever, or the like, information output from a contact sensor mounted in the vehicle, image information of a camera capturing the surroundings of the vehicle, and other information are conceivable.

As information output from the contact sensor, for example, in addition to information indicating that a passenger has touched a door knob which is operated in opening a door, operation detection information in the case where an operation within a range of play is performed on a steering wheel, an accelerator, and a brake and other information are conceivable.

The operation detection processing unit 3 is implemented by an operation detection processing circuit 22 in FIG. 2 for example, and performs processing of detecting an operation on the vehicle from the vehicle information acquired by the vehicle information acquiring unit 2.

A display data outputting unit 4 includes a display data storing unit 5 and a display data selecting unit 6 and performs processing of outputting display data of pre-notification information.

The display data storing unit 5 is implemented by a display data storage processing circuit 23 in FIG. 2 for example, and stores, for each operation on the vehicle, display data of pre-notification information for pre-notifying the motion accompanying the operation.

The display data selecting unit 6 is implemented by a display data selection processing circuit 24 in FIG. 2, and performs processing of selecting, from among a plurality of pieces of display data stored in the display data storing unit 5, display data of pre-notification information for pre-notifying the motion accompanying the operation detected by the operation detection processing unit 3.

An information presenting unit 7 is implemented by an information presentation processing circuit 25 in FIG. 2 for example, and performs processing of displaying the pre-notification information to the outside of the vehicle in accordance with the display data output from the display data outputting unit 4.

That is, the information presenting unit 7 includes a light emitting unit 7a for displaying the pre-notification information on a projection surface in accordance with the display data output from the display data outputting unit 4 for example by irradiating the projection surface outside the vehicle with laser light or light emitting diode (LED) light.

As the projection surface of light, a road surface around the vehicle, the body of the vehicle, a window of the vehicle, and the like are conceivable, and the body and a window of the vehicle are included as the projection surface outside the vehicle.

In the first embodiment, it is assumed that the information presenting unit 7 displays pre-notification information on the outside of the vehicle; however, pre-notification information may be output by speech to the outside of the vehicle.

Here, the example in which the medium of the information presenting unit 7, on which information is displayed, is a road surface around the vehicle, the body or a window of the vehicle is illustrated; however, for example, a display device including a plurality of light emitting elements and attached inside a lighting device such as a headlight, an indicator, or a stop light or to the body or other parts of the vehicle or a display attached to the body or other parts of the vehicle may be employed as the display medium. The information presenting unit 7 may display pre-notification information on the display device or the display.

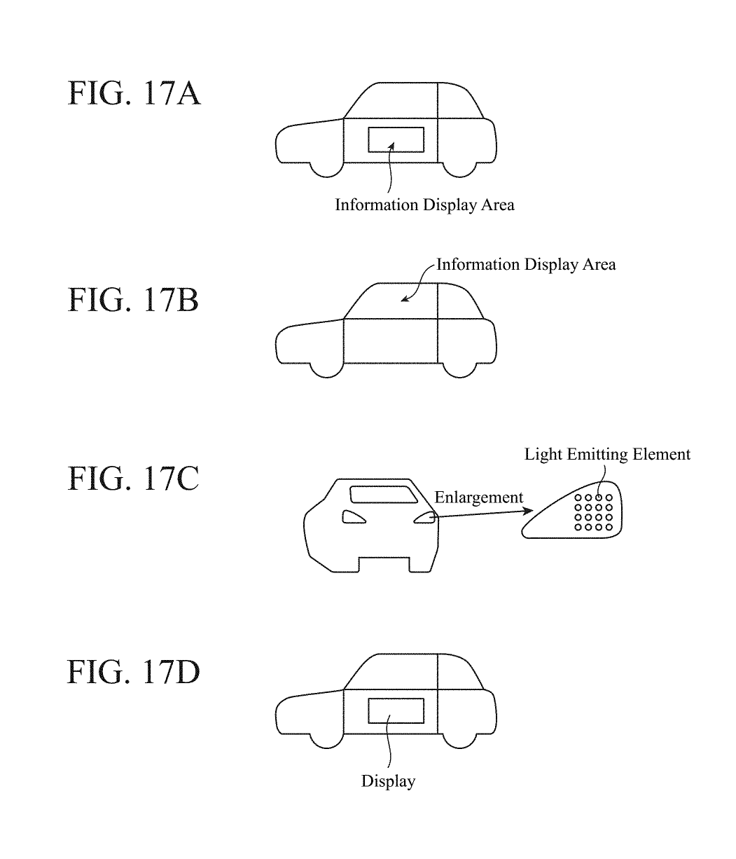

FIG. 17 is an explanatory diagram illustrating an example of a medium of the information presenting unit 7 on which pre-notification information is displayed.

FIG. 17A is a diagram illustrating an example in which the medium on which pre-notification information is displayed is the body of the vehicle, FIG. 17B is a diagram illustrating an example in which the medium on which pre-notification information is displayed is a window of the vehicle, FIG. 17C is a diagram illustrating an example in which the medium on which pre-notification information is displayed is a display device including a plurality of light emitting elements, and FIG. 17D is a diagram illustrating an example in which a medium on which pre-notification information is displayed is a display attached to the body of the vehicle.

A motion control unit 8 is implemented by a motion control processing circuit 26 in FIG. 2 for example and performs processing of controlling the motion accompanying the operation detected by the operation detecting unit 1.

A situation notifying unit 9 is implemented by a situation notification processing circuit 27 in FIG. 2 for example and performs processing of notifying the situation in which the motion is controlled by the motion control unit 8.

In FIG. 1, it is assumed that each of the vehicle information acquiring unit 2, the operation detection processing unit 3, the display data storing unit 5, the display data selecting unit 6, the information presenting unit 7, the motion control unit 8, and the situation notifying unit 9 that are components of the vehicle control device is implemented by dedicated hardware as illustrated in FIG. 2, that is, the vehicle information acquiring circuit 21, the operation detection processing circuit 22, the display data storage processing circuit 23, the display data selection processing circuit 24, the information presentation processing circuit 25, the motion control processing circuit 26, and the situation notification processing circuit 27, respectively.

Here, the display data storage processing circuit 23 may be a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disc, a flexible disc, an optical disc, a compact disc, a mini disc, a digital versatile disc (DVD), or the like.

The vehicle information acquiring circuit 21, the operation detection processing circuit 22, the display data selection processing circuit 24, the information presentation processing circuit 25, the motion control processing circuit 26, and the situation notification processing circuit 27 may be a single circuit, a composite circuit, a programmed processor, a parallel-programmed processor, an application specific integrated circuit (ASIC), a field-programmable gate array (FPGA), or a combination thereof.

Moreover, the components of the vehicle control device are not limited to those implemented by dedicated hardware, and the vehicle control device may be implemented by software, firmware, or a combination of software and firmware.

The software or the firmware is stored in a memory of a computer as a program. Here, a computer refers to hardware for executing a program and may be, for example, a central processing unit (CPU), a central processing device, a processing device, an arithmetic device, a microprocessor, a microcomputer, a processor, a digital signal processor (DSP), or the like.

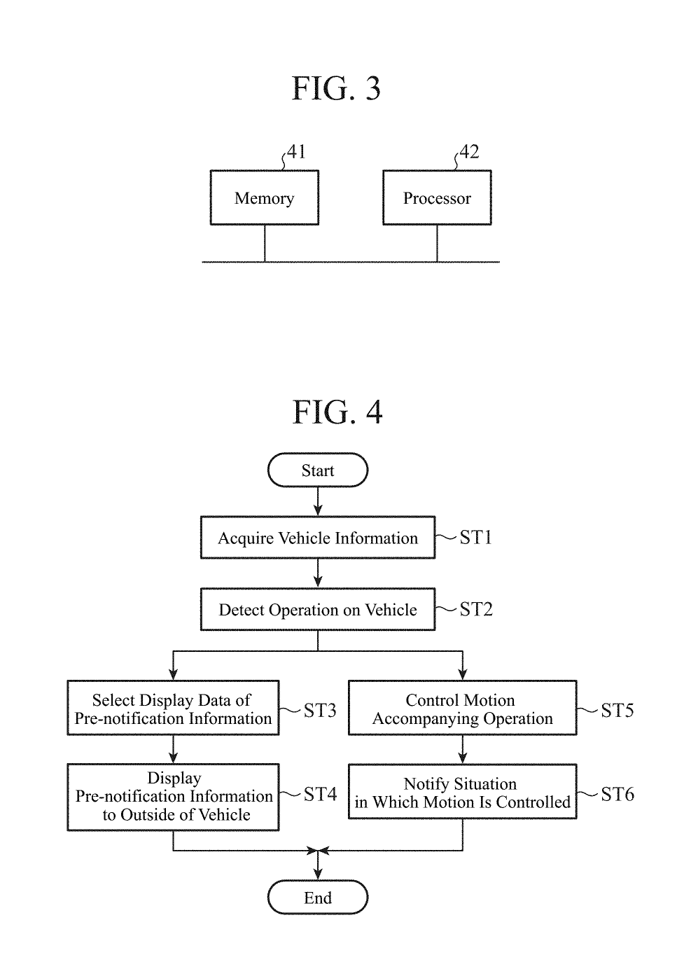

FIG. 3 is a diagram illustrating a hardware configuration of a computer in the case where the vehicle control device is implemented by software, firmware, and the like.

In the case where the vehicle control device is implemented by software, firmware, or the like, it is only required that the display data storing unit 5 is configured on a memory 41 of a computer, a program for causing the computer to execute processing procedures of the vehicle information acquiring unit 2, the operation detection processing unit 3, the display data selecting unit 6, the information presenting unit 7, the motion control unit 8, and the situation notifying unit 9 is stored in the memory 41, and that a processor 42 of the computer executes the program stored in the memory 41.

FIG. 4 is a flowchart illustrating a vehicle control method which is a processing procedure of the vehicle control device according to the first embodiment of the present invention.

FIG. 2 illustrates an example in which each of the components of the vehicle control device is implemented by dedicated hardware, and FIG. 3 illustrates an example in which the vehicle control device is implemented by software, firmware, or the like. However, some of the components of the vehicle control device may be implemented by dedicated hardware and the rest of the components may be implemented by software, firmware, or the like.

For example, the vehicle information acquiring unit 2 and the information presenting unit 7 can be implemented by dedicated hardware, while the operation detection processing unit 3, the display data storing unit 5, the display data selecting unit 6, the motion control unit 8, and the situation notifying unit 9 can be implemented by software, firmware, or the like. Note that any combination of dedicated hardware and software may be employed.

Next, the operation will be described.

The vehicle information acquiring unit 2 of the operation detecting unit 1 acquires vehicle information indicating the state of the vehicle from an onboard device through an in-vehicle network and outputs the vehicle information to the operation detection processing unit 3 (step ST1 in FIG. 4).

In the first embodiment, for example in addition to CAN data, information output from a contact sensor mounted on the vehicle, image information of a camera capturing the surroundings of the vehicle, and other information are acquired as vehicle information.

Upon receiving the vehicle information from the vehicle information acquiring unit 2, the operation detection processing unit 3 detects an operation on the vehicle from the vehicle information (step ST2).

For example, in a case where the vehicle information acquired by the vehicle information acquiring unit 2 includes information indicating that a passenger has touched a door knob which is operated in opening the door, an operation indicating an intension to open the door is detected as the operation on the vehicle. Hereinafter, this operation is referred to as “door opening operation”.

In addition, in the case where the vehicle information acquired by the vehicle information acquiring unit 2 includes information of an operation of the indicator, an operation indicating an intension to turn right or left or to merge into another lane is detected as the operation on the vehicle. Hereinafter, this operation is referred to as “turning right/left operation”.

In the case where the vehicle information acquired by the vehicle information acquiring unit 2 includes information of an operation indicating that the shift lever has switched from the parking position to the drive position or the reverse position, an operation indicating an intension to start the vehicle is detected as the operation on the vehicle. Hereinafter, this operation is referred to as “starting operation”.

In addition, in the case where the vehicle information acquired by the vehicle information acquiring unit 2 includes information of an operation of a button indicating an intension to give way, an operation indicating an intension to give way to other vehicles or pedestrians is detected. Hereinafter, this operation is referred to as “give way operation”.

In the display data storing unit 5 of the display data outputting unit 4, for each operation on the vehicle, display data of pre-notification information for pre-notifying the motion accompanying the operation is stored.

In the first embodiment, it is assumed that the display data is for example an animation including pre-notification information to be presented outside the vehicle; however, the display data may be a still image without being limited to an animation. What is included in the animated display data is, for example, data of a moving image pattern that represents a direction of a traveling direction such as a pattern or an arrow conforming to general road rules.

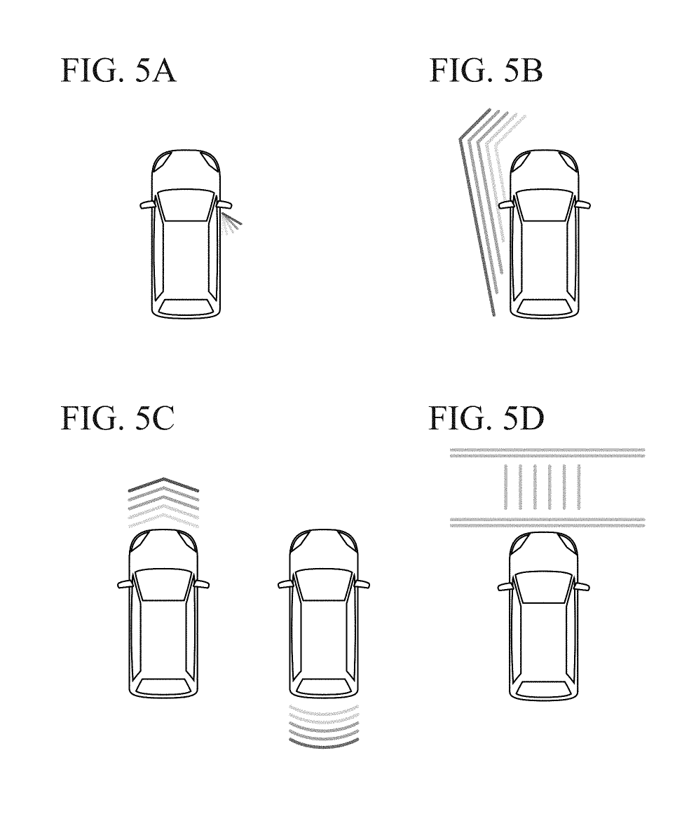

FIG. 5 includes explanatory diagrams each illustrating an example of display data of pre-notification information stored in the display data storing unit 5.

For example, as display data of pre-notification information corresponding to “door opening operation”, display data of pre-notification information for pre-notifying that a door opens soon is stored. FIG. 5A illustrates an example of display data of pre-notification information for pre-notifying that a door opens. In this case, pre-notification information of a figure for calling attention to the operation of opening the door is displayed from the vicinity of a side mirror to the outside of the vehicle.

For example, as the display data of pre-notification information corresponding to the “turning right/left operation”, display data of pre-notification information for pre-notifying that the vehicle soon turns right or left or merges into another lane is stored. FIG. 5B illustrates an example of display data of pre-notification information for pre-notifying a right or a left turn. In this case, pre-notification information of a figure simulating an indicator is displayed on a road surface on the front side to the side of the vehicle.

For example, as display data of pre-notification information corresponding to “starting operation”, display data of pre-notification information for pre-notifying that the vehicle soon starts is stored. FIG. 5C illustrates an example of display data of pre-notification information for pre-notifying starting of the vehicle. In this case, pre-notification information of a figure indicating a traveling direction is displayed on a road surface in front of the vehicle when the vehicle starts traveling forward. Alternatively, when the vehicle starts traveling backward, pre-notification information of a figure indicating a traveling direction is displayed on a road surface behind the vehicle.

For example, as display data of pre-notification information corresponding to “give way operation”, display data of pre-notification information for pre-notifying intention of giving way to other vehicles or pedestrians is stored. FIG. 5D illustrates an example of display data of pre-notification information for pre-notifying the intention of giving way. In this case, pre-notification information of a figure simulating a pedestrian crossing is displayed on a road surface in front of the vehicle.

The display data selecting unit 6 of the display data outputting unit 4 selects display data of pre-notification information for pre-notifying a motion accompanying the operation detected by the operation detection processing unit 3 from among the plurality of pieces of display data stored in the display data storing unit 5 and outputs the display data to the information presenting unit 7 (step ST3 in FIG. 4).

That is, in the case where an operation on the vehicle is “door opening operation” for example, the display data selecting unit 6 selects the display data as illustrated in FIG. 5A.

In the case where an operation on the vehicle is “turning right/left operation” for example, the display data selecting unit 6 selects the display data as illustrated in FIG. 5B.

In the case where an operation on the vehicle is “starting operation” for example, the display data selecting unit 6 selects the display data as illustrated in FIG. 5C.

In the case where an operation on the vehicle is “give way operation” for example, the display data selecting unit 6 selects the display data as illustrated in FIG. 5D.

Upon receiving the display data from the display data outputting unit 4, the information presenting unit 7 displays the pre-notification information to the outside of the vehicle in accordance with the display data (step ST4 in FIG. 4).

That is, the light emitting unit 7a of the information presenting unit 7 displays the pre-notification information on a projection surface in accordance with the display data output from the display data outputting unit 4, for example, by irradiating the projection surface outside the vehicle with laser light or LED light.

The example in which the light emitting unit 7a of the information presenting unit 7 displays the pre-notification information on the projection surface is illustrated here; however, the pre-notification information may be displayed on a display device including a plurality of light emitting elements and attached inside a lighting device or to the body or other parts of the vehicle or a display attached to the body or other parts of the vehicle.

When the operation detecting unit 1 detects an operation on the vehicle, the motion control unit 8 controls the motion accompanying the operation (step ST5).

That is, the motion control unit 8 restricts the motion accompanying the operation detected by the operation detecting unit 1 until a certain period of time elapses after the operation detecting unit 1 has detected the operation on the vehicle. The certain period of time is time set in advance, and any time such as one second or two seconds is set, for example.

For example in the case where the operation on the vehicle is “door opening operation”, although pre-notification information for pre-notifying that the door will soon be opened is immediately displayed by the information presenting unit 7, the motion control unit 8 controls such that the door does not open until a certain period of time elapses.

As a result, the door does not suddenly open, and others can recognize that the door will open by looking at the pre-notification information, and thus occurrence of a minor collision caused by opening the door can be prevented. Here, the others include drivers of other vehicles or pedestrians present around the vehicle.

Furthermore, for example in the case where the operation on the vehicle is “turning right/left operation”, although pre-notification information for pre-notifying that the vehicle soon turns right or left or merges into another lane is immediately displayed by the information presenting unit 7, the motion control unit 8 controls a steering wheel or a driving system of the vehicle such that the vehicle cannot turn right or left or merge into another lane until a certain period of time elapses.

As a result, a right or a left turn or the like is not performed suddenly, and others can recognize that a right or a left turn or the like will be performed by looking at the pre-notification information, and thus occurrence of a minor collision caused by the right or the left turn or the like can be prevented.

Furthermore, for example in the case where the operation on the vehicle is “starting operation”, although pre-notification information for pre-notifying that the vehicle will soon start is immediately displayed by the information presenting unit 7, the motion control unit 8 controls the driving system of the vehicle such that the vehicle cannot start until a certain period of time elapses.

As a result, the vehicle does not suddenly start, and others can recognize that the vehicle will start by looking at the pre-notification information, and thus occurrence of a minor collision caused by the start of the vehicle can be prevented.

Furthermore, for example in the case where the operation on the vehicle is “give way operation”, although pre-notification information for pre-notifying an intention of giving way is immediately displayed by the information presenting unit 7, the motion control unit 8 controls the driving system of the vehicle such that the vehicle cannot start until a certain period of time elapses.

As a result, with others looking at the pre-notification information, pedestrians or the like can safely cross a road.

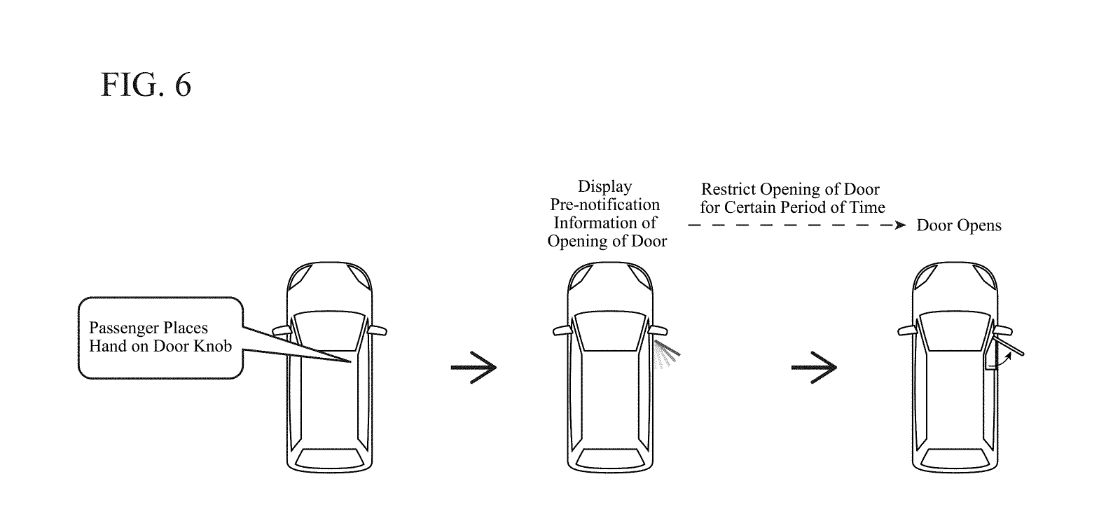

Here, FIG. 6 is an explanatory view showing a control example in the case where the operation on the vehicle is the “door opening operation”.

The example of FIG. 6 illustrates that pre-notification information for pre-notifying opening of a door is displayed since a passenger has touched the door knob and that the door is controlled not to be opened for a certain period of time.

The situation notifying unit 9 notifies the passenger of the vehicle of the situation in which the motion is controlled by the motion control unit 8 (step ST6).

For example, information indicating that the motion accompanying the operation detected by the operation detecting unit 1 is restricted until a certain period of time elapses is displayed on a display or the like of a navigation device.

Alternatively, information indicating that the motion accompanying the operation detected by the operation detecting unit 1 is restricted until a certain period of time elapses is output as speech.

Alternatively, information indicating that the motion accompanying the operation is restricted is notified by vibration, a smell, or the like.

As is clear from the above, according to the first embodiment, the information presenting unit 7 presents pre-notification information for pre-notifying motion accompanying an operation detected by the operation detecting unit 1 to the outside of the vehicle, and the motion control unit 8 controls the motion accompanying the operation detected by the operation detecting unit 1, thereby achieving an effect that occurrence of a dangerous situation can be prevented.

### Second Embodiment

In the first embodiment, the motion control unit 8 restricts the motion accompanying an operation detected by the operation detecting unit 1 until a certain period of time elapses after the operation detecting unit 1 has detected the operation on the vehicle. In the second embodiment, however, whether other vehicles or pedestrians are present around the vehicle is determined, and if another vehicle or a pedestrian is present around the vehicle, a motion control unit 12 restricts the motion accompanying the operation detected by an operation detecting unit 1.

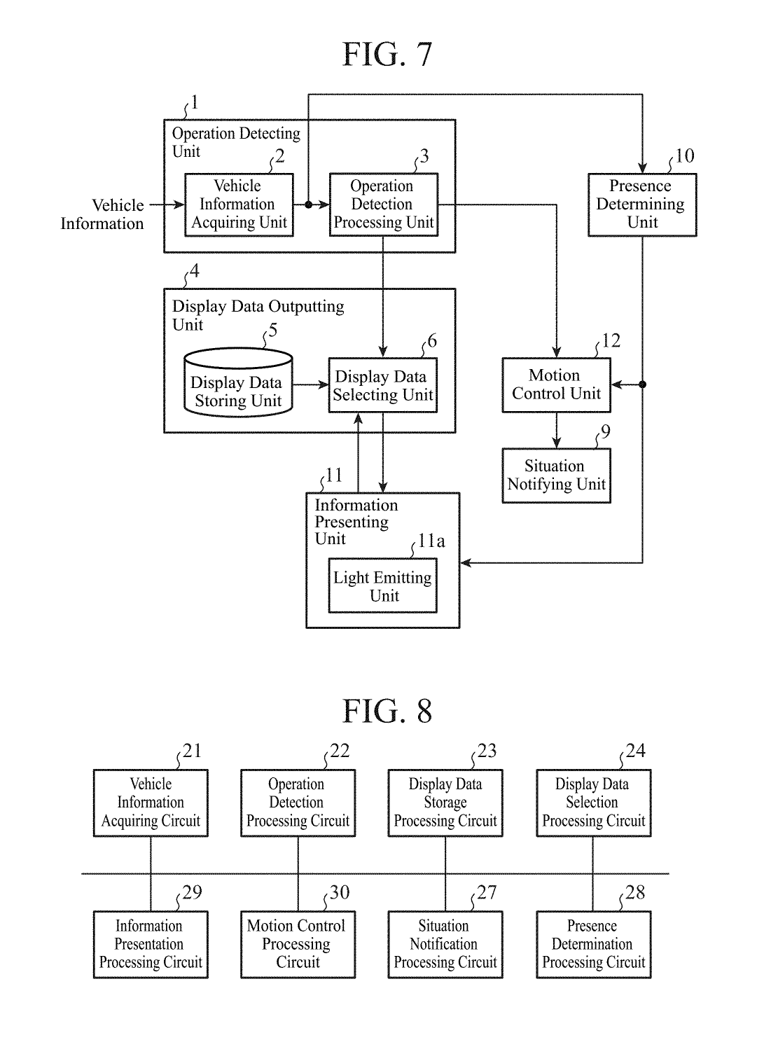

FIG. 7 is a diagram illustrating a configuration of a vehicle control device according to the second embodiment of the present invention. FIG. 8 is a diagram illustrating a hardware configuration of the vehicle control device according to the second embodiment of the present invention.

In FIGS. 7 and 8, the same symbol as that in FIGS. 1 and 2 represents the same or a corresponding part and thus descriptions thereof are omitted.

A presence determining unit 10 is implemented by a presence determination processing circuit 28 in FIG. 8 which is formed of, for example, a semiconductor integrated circuit on which a CPU is mounted, a one-chip microcomputer, or the like and performs processing of determining whether another vehicle or a pedestrian is present around a vehicle from image information of a camera capturing the surroundings of the vehicle out of vehicle information acquired by a vehicle information acquiring unit 2.

An information presenting unit 11 is implemented by, for example, an information presentation processing circuit 29 of FIG. 8. The information presenting unit 11 displays pre-notification information on the outside of the vehicle in accordance with display data output from a display data outputting unit 4 when it is determined by the presence determining unit 10 that another vehicle or a pedestrian is present and performs processing to stop displaying the pre-notification information when it is determined by the presence determining unit 10 that no other vehicle or pedestrian is present.

The information presenting unit 11 has a light emitting unit 11a for displaying the pre-notification information on a projection surface in accordance with the display data output from the display data outputting unit 4 for example by irradiating the projection surface outside the vehicle with laser light or LED light.

In the second embodiment, it is assumed that the information presenting unit 11 displays pre-notification information on the outside of the vehicle; however, pre-notification information may be output by speech to the outside of the vehicle.

Moreover, in the second embodiment, a road surface around the vehicle or the body or a window of the vehicle is assumed as the medium on which pre-notification information in the information presenting unit 11 is displayed; however, for example, a display device including a plurality of light emitting elements and attached inside a lighting device such as a headlight, an indicator, or a stop light or to the body or other parts of the vehicle or a display attached to the body or other parts of the vehicle may be employed as the display medium. The information presenting unit 11 may display pre-notification information on the display device or the display.

A motion control unit 12 is implemented by, for example, a motion control processing circuit 30 of FIG. 8. The motion control unit 12 restricts the motion accompanying the operation detected by the operation detecting unit 1 when it is determined by the presence determining unit 10 that another vehicle or a pedestrian is present and performs processing to allow the motion accompanying the operation detected by the operation detecting unit 1 when it is determined by the presence determining unit 10 that no other vehicle or pedestrian is present.

In FIG. 7, it is assumed that each of the vehicle information acquiring unit 2, the operation detection processing unit 3, the display data storing unit 5, the display data selecting unit 6, the presence determining unit 10, the information presenting unit 11, the motion control unit 12, and the situation notifying unit 9 that are components of the vehicle control device is implemented by dedicated hardware as illustrated in FIG. 8, that is, the vehicle information acquiring circuit 21, the operation detection processing circuit 22, the display data storage processing circuit 23, the display data selection processing circuit 24, the presence determination processing circuit 28, the information presentation processing circuit 29, the motion control processing circuit 30, and the situation notification processing circuit 27, respectively.

Moreover, the components of the vehicle control device are not limited to those implemented by dedicated hardware, and the vehicle control device may be implemented by software, firmware, or a combination of software and firmware.

In the case where the vehicle control device is implemented by software, firmware, or the like, it is only required that the display data storing unit 5 is configured on the memory 41 of the computer illustrated in FIG. 3, a program for causing the computer to execute processing procedures of the vehicle information acquiring unit 2, the operation detection processing unit 3, the display data selecting unit 6, the presence determining unit 10, the information presenting unit 11, the motion control unit 12, and the situation notifying unit 9 is stored in the memory 41, and that the processor 42 of the computer executes the program stored in the memory 41.

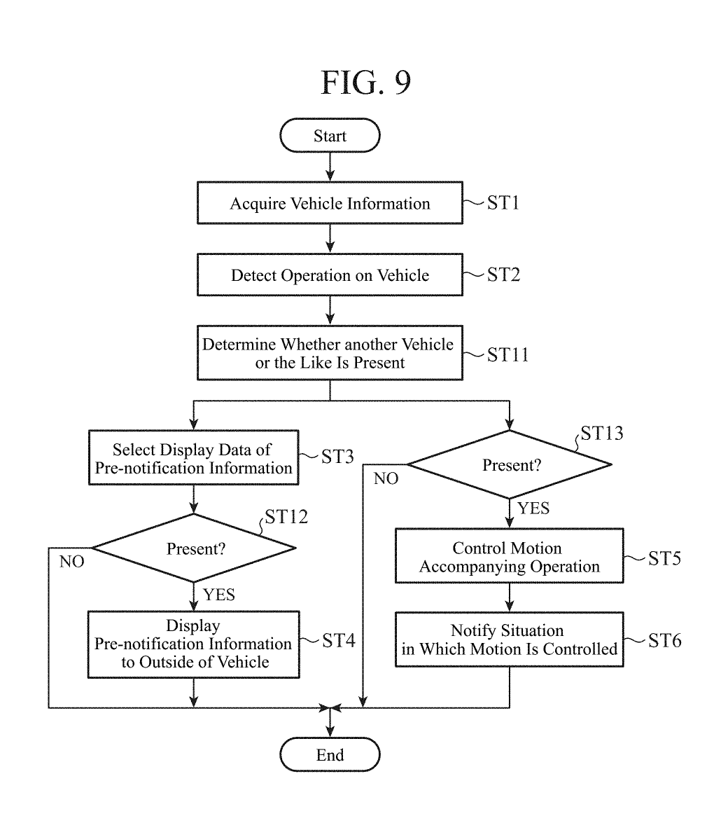

FIG. 9 is a flowchart illustrating a vehicle control method which is a processing procedure of the vehicle control device according to the second embodiment of the present invention. In FIG. 9, the same symbol as that in FIG. 4 represents the same or a corresponding part and thus descriptions thereof are omitted.

Next, the operation will be described.

Note that since the content of processing is similar to that of the first embodiment described above except for those of the presence determining unit 10, the information presenting unit 11, and the motion control unit 12, the content of processing of the presence determining unit 10, the information presenting unit 11, and the motion control unit 12 will be explained here.

Upon receiving the image information of the camera photographing the surroundings of the vehicle out of the vehicle information from the vehicle information acquiring unit 2, the presence determining unit 10 determines whether another vehicle or a pedestrian is present around the vehicle from the image information of the camera by executing a well-known algorithm of object recognition processing (step ST11 in FIG. 9).

The information presenting unit 11 displays pre-notification information on the outside of the vehicle in accordance with display data output from the display data outputting unit 4 if it is determined by the presence determining unit 10 that another vehicle or a pedestrian is present (YES in step ST12) like the information presenting unit 7 does in the first embodiment described above (step ST4).

If it is determined by the presence determining unit 10 that no other vehicle or pedestrian is present (NO in step ST12), the information presenting unit 11 stops displaying the pre-notification information.

The information presenting unit 11 controls displaying of the pre-notification information on the basis of the determination result by the presence determining unit 10; however, the display data selecting unit 6 may select and output display data to the information presenting unit 11 when it is determined by the presence determining unit 10 that another vehicle or a pedestrian is present and may not output the display data to the information presenting unit 11 when it is determined by the presence determining unit 10 that no other vehicle or pedestrian is present.

If it is determined by the presence determining unit 10 that another vehicle or a pedestrian is present (YES in step ST13), the motion control unit 12 performs control to restrict the motion accompanying the operation detected by the operation detecting unit 1 like the motion control unit 8 does in the first embodiment described above (step ST5).

If it is determined by the presence determining unit 10 that no other vehicle or pedestrian is present (NO in step ST13), the motion control unit 12 allows the motion without restricting the motion accompanying the operation detected by the operation detecting unit 1.

As is apparent from the above description, according to the second embodiment, the presence determining unit 10 for determining whether another vehicle or a pedestrian is present around the vehicle is further included, and the information presenting unit 11 displays pre-notification information on the outside of the vehicle in accordance with the display data output from the display data outputting unit 4 when it is determined by the presence determining unit 10 that another vehicle or a pedestrian is present and, when it is determined by the presence determining unit 10 that no other vehicle or pedestrian is present, stops displaying the pre-notification information. Therefore, in addition to that pre-notification of the motion accompanying the operation can be performed like in the first embodiment, it is possible to stop unnecessary notice when no other vehicle or pedestrian is present.

Furthermore, according to the second embodiment, the presence determining unit 10 for determining whether another vehicle or a pedestrian is present around the vehicle is further included, and the motion control unit 12 restricts the motion accompanying the operation detected by the operation detecting unit 1 when it is determined by the presence determining unit 10 that another vehicle or a pedestrian is present and, when it is determined by the presence determining unit 10 that no other vehicle or pedestrian is present, allows the motion accompanying the operation detected by the operation detecting unit 1. Therefore, in addition to that occurrence of a dangerous situation can be prevented like in the first embodiment, it is possible to improve operability of the vehicle when no other vehicle or pedestrian is present.

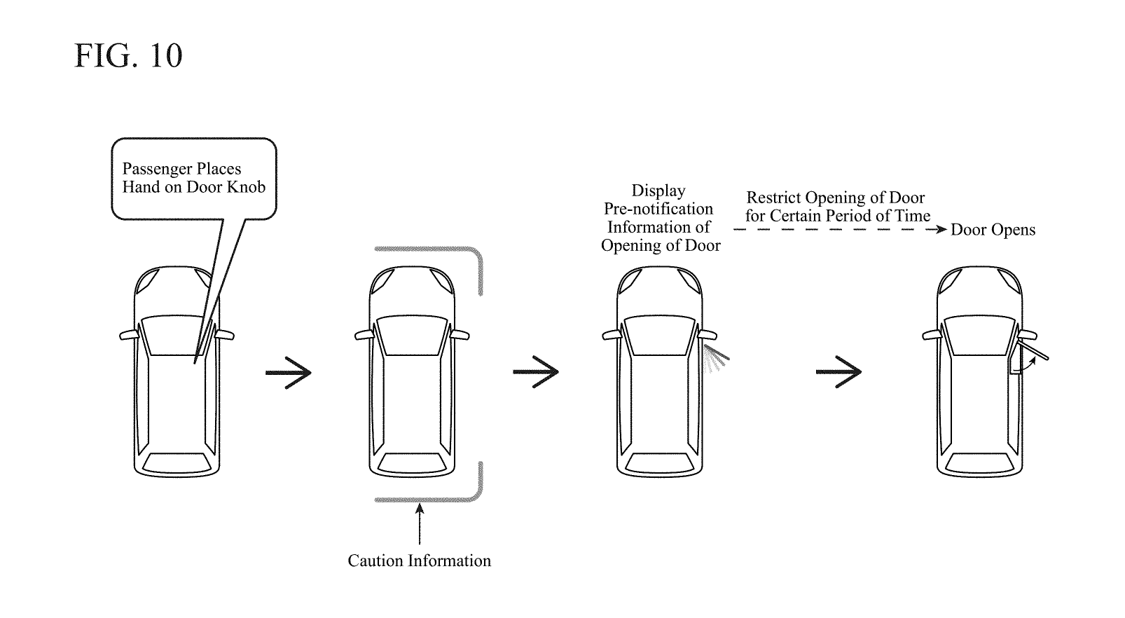

In the second embodiment, the information presenting unit 11 displays pre-notification information on the outside of the vehicle in accordance with the display data output from the display data outputting unit 4 when it is determined by the presence determining unit 10 that another vehicle or a pedestrian is present and, when it is determined by the presence determining unit 10 that no other vehicle or pedestrian is present, stops displaying the pre-notification information. However, the information presenting unit 11 may immediately present caution information for calling attention on the outside of the vehicle regardless of the determination result of the presence determining unit 10 as illustrated in FIG. 10 when the operation detecting unit 1 detects an operation on the vehicle.

FIG. 10 is an explanatory diagram illustrating a display example of caution information by the information presenting unit 11, and in the example of FIG. 10, caution information for calling attention to a road surface around the vehicle is displayed.

### Third Embodiment

In the second embodiment, when it is determined by the presence determining unit 10 that another vehicle or a pedestrian is present, the information presenting unit 11 displays pre-notification information on the outside of the vehicle in accordance with the display data output from the display data outputting unit 4, and the motion control unit 12 restricts the motion accompanying the operation detected by the operation detecting unit 1. In the third embodiment, however, a relative state with another vehicle or a pedestrian is detected, and displaying of pre-notification information and the motion accompanying an operation are controlled depending on the relative state.

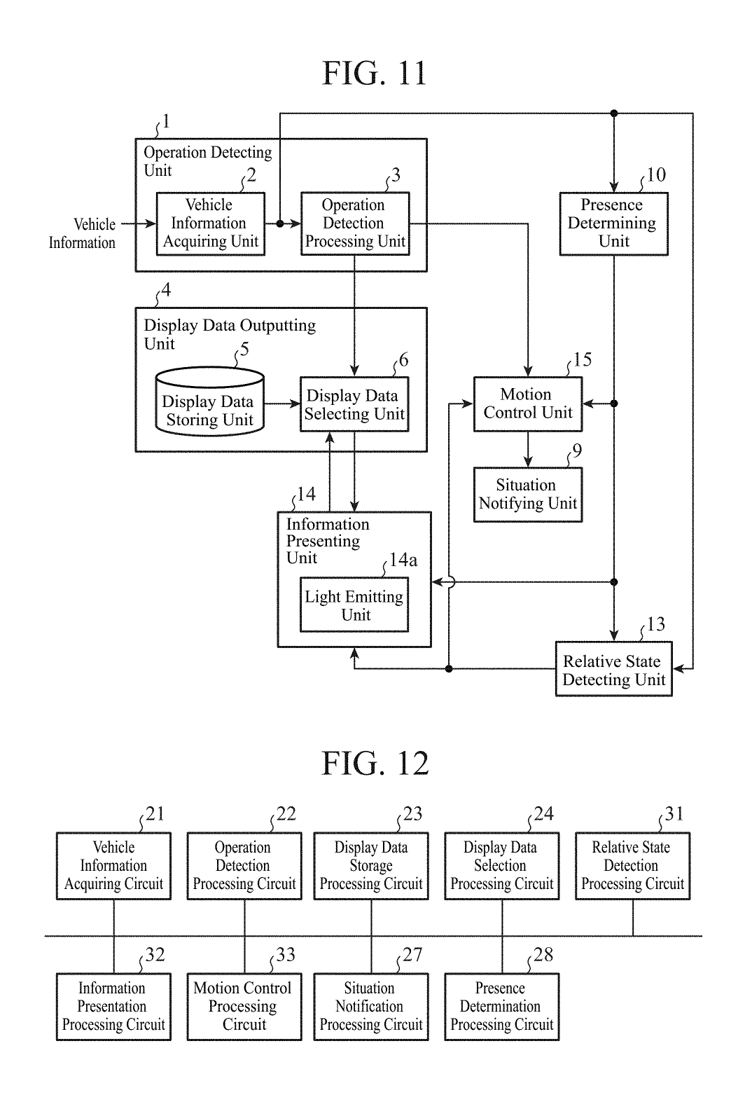

FIG. 11 is a diagram illustrating a configuration of a vehicle control device according to the third embodiment of the present invention. FIG. 12 is a diagram illustrating a hardware configuration of the vehicle control device according to the third embodiment of the present invention.

In FIGS. 11 and 12, the same symbol as that in FIGS. 7 and 8 represents the same or a corresponding part and thus descriptions thereon are omitted.

A relative state detecting unit 13 is implemented by a relative state detection processing circuit 31 in FIG. 12 which is formed by, for example, a semiconductor integrated circuit on which a CPU is mounted, a one-chip microcomputer, or the like and, when it is determined by a presence determining unit 10 that another vehicle or a pedestrian is present, performs processing of detecting a relative state with the other vehicle or a pedestrian from image information of a camera photographing the surroundings of a vehicle out of vehicle information acquired by a vehicle information acquiring unit 2.

An information presenting unit 14 is implemented by, for example, an information presentation processing circuit 32 of FIG. 12. The information presenting unit 14 displays pre-notification information on the outside of the vehicle in accordance with display data output from a display data outputting unit 4 when it is determined by the presence determining unit 10 that another vehicle or a pedestrian is present and performs processing to stop displaying the pre-notification information when it is determined by the presence determining unit 10 that no other vehicle or pedestrian is present.

Like the information presenting unit 11 in FIG. 7, the information presenting unit 14 has a light emitting unit 14a for displaying the pre-notification information on a projection surface in accordance with the display data output from a display data outputting unit 4 for example by irradiating the projection surface outside the vehicle with laser light or LED light.

However, unlike the information presenting unit 11 in FIG. 7, the information presenting unit 14 acquires display data of pre-notification information corresponding to the relative state by instructing a display data selecting unit 6 to switch pre-notification information depending on the relative state detected by the relative state detecting unit 13 and displays the pre-notification information on the outside of the vehicle in accordance with the display data.

A motion control unit 15 is implemented by, for example, a motion control processing circuit 33 in FIG. 12. Like the motion control unit 12 in FIG. 7, the motion control unit 12 restricts the motion accompanying an operation detected by an operation detecting unit 1 when it is determined by the presence determining unit 10 that another vehicle or a pedestrian is present and performs processing to allow the motion accompanying the operation detected by the operation detecting unit 1 when it is determined by the presence determining unit 10 that no other vehicle or pedestrian is present.

Note that, unlike the motion control unit 12 in FIG. 7, the motion control unit 15 controls the motion accompanying the operation detected by the operation detecting unit 1 depending on the relative state detected by the relative state detecting unit 13.

In FIG. 11, it is assumed that each of the vehicle information acquiring unit 2, the operation detection processing unit 3, the display data storing unit 5, the display data selecting unit 6, the presence determining unit 10, the relative state detecting unit 13, the information presenting unit 14, the motion control unit 15, and the situation notifying unit 9 that are components of the vehicle control device is implemented by dedicated hardware as illustrated in FIG. 12, that is, the vehicle information acquiring circuit 21, the operation detection processing circuit 22, the display data storage processing circuit 23, the display data selection processing circuit 24, the presence determination processing circuit 28, the relative state detection processing circuit 31, the information presentation processing circuit 32, the motion control processing circuit 33, and the situation notification processing circuit 27, respectively.

Moreover, the components of the vehicle control device are not limited to those implemented by dedicated hardware, and the vehicle control device may be implemented by software, firmware, or a combination of software and firmware.

In the case where the vehicle control device is implemented by software, firmware, or the like, it is only required that the display data storing unit 5 is configured on the memory 41 of the computer illustrated in FIG. 3, a program for causing the computer to execute processing procedures of the vehicle information acquiring unit 2, the operation detection processing unit 3, the display data selecting unit 6, the presence determining unit 10, the relative state detecting unit 13, the information presenting unit 14, the motion control unit 15, and the situation notifying unit 9 is stored in the memory 41, and that the processor 42 of the computer executes the program stored in the memory 41.

Next, the operation will be described.

Since the content of processing is similar to that of the second embodiment described above except for those of the relative state detecting unit 13, the information presenting unit 14, and the motion control unit 15, the content of processing of the relative state detecting unit 13, the information presenting unit 14, and the motion control unit 15 will be mainly explained here.

When it is determined by the presence determining unit 10 that another vehicle or a pedestrian is present, the relative state detecting unit 13 detects a relative state with another vehicle or a pedestrian from the image information of the camera photographing the surroundings of the vehicle out of the vehicle information acquired by the vehicle information acquiring unit 2.

Hereinafter, the processing of detecting a relative state between a host vehicle and another vehicle or a pedestrian by the relative state detecting unit 13 will be specifically described.

The relative state detecting unit 13 prestores front images and rear images of various vehicles such as ordinary passenger cars, trucks, buses, motorcycles, and bicycles as reference images and further stores front images and rear images of pedestrians as reference images.

Upon receiving the image information of the camera, the relative state detecting unit 13 detects an object present around the host vehicle from the image information by executing a well-known algorithm of object recognition processing.

When detecting an object present around the host vehicle, the relative state detecting unit 13 collates an image of the object with a plurality of reference images prestored therein.

Then, the relative state detecting unit 13 specifies a reference image having the highest similarity in feature points to the image of the object out of the plurality of reference images and, in the case where the identified reference image is a front image of a vehicle or a pedestrian, determines that the host vehicle and the other vehicle or the pedestrian are traveling in the opposite directions.

In contrast, in the case where the image is a rear image of a vehicle or a pedestrian, it is determined that the host vehicle and another vehicle or a pedestrian are traveling in the same direction.

The relative state detecting unit 13 recognizes, as the relative state between the host vehicle and another vehicle or a pedestrian, traveling directions of the host vehicle and the other vehicle or the pedestrian, that is, whether traveling in opposite directions or in the same direction.

In addition, for example in the case where a transceiver capable of transmitting light such as laser light or infrared rays or the like toward another vehicle or a pedestrian and then receiving the light or the like returning after being reflected on the other vehicle or the pedestrian is included, the relative state detecting unit 13 calculates, as a relative state between the host vehicle and the other vehicle or the pedestrian, a relative speed between the host vehicle and the other vehicle or the pedestrian from a time length from transmission of light or the like from the transceiver to the other vehicle or the pedestrian to reception of the laser light by the transceiver. Since the speed of light is known, the relative speed of the host vehicle with respect to the other vehicle or the pedestrian can be calculated from a time difference between transmission time and reception time of light.

The relative state detecting unit 13 further calculates a relative distance of the host vehicle with respect to the other vehicle or the pedestrian as a relative state between the host vehicle and the other vehicle or the pedestrian from the time difference between transmission time and reception time of light.

In the display data storing unit 5 of the display data outputting unit 4, for each operation on the vehicle, display data of pre-notification information for pre-notifying the motion accompanying the operation is stored like in the first and the second embodiments; however in the third embodiment, display data of pre-notification information is stored further for each relative state between the host vehicle and another vehicle or a pedestrian.

In the case where it is determined by the presence determining unit 10 that another vehicle or a pedestrian is present, and display data output from the display data outputting unit 4 corresponds to the relative state detected by the relative state detecting unit 13, the information presenting unit 14 displays pre-notification information on the outside of the vehicle in accordance with the display data like the information presenting unit 11 of the second embodiment does.

In the case where the display data output from the display data outputting unit 4 does not correspond to the relative state detected by the relative state detecting unit 13, the information presenting unit 14 outputs a command to output display data corresponding to the relative state to the display data outputting unit 4. It is assumed that the output command includes information indicating the relative state.

When receiving the output instruction of the display data corresponding to the relative state, the display data selecting unit 6 of the display data outputting unit 4 refers to information indicating the relative state included in the output command, selects display data corresponding to the relative state out of a plurality of pieces of display data stored in the display data storing unit 5, and outputs the display data to the information presenting unit 14.

Upon receiving the display data from the display data outputting unit 4, the information presenting unit 14 displays pre-notification information on the outside of the vehicle in accordance with the display data.

When it is determined by the presence determining unit 10 that no other vehicle or pedestrian is present, the motion control unit 15 allows the motion without restricting the motion accompanying the operation detected by the operation detecting unit 1 like the motion control unit 12 does in the second embodiment.

When it is determined by the presence determining unit 10 that another vehicle or a pedestrian is present, the motion control unit 15 controls the motion accompanying the operation detected by the operation detecting unit 1 depending on the relative state detected by the relative state detecting unit 13.

Here, a specific example of pre-notification information corresponding to a relative state and control of the motion accompanying an operation will be described.

For example, display data of pre-notification information in the case where an operation on the vehicle is “door opening operation” may be the display data as illustrated in FIG. 5A. Meanwhile, for example, as a position where another vehicle or a pedestrian is present is closer to the host vehicle, the risk of “door opening operation” is higher. Also, the wider an opening angle of the door, the higher the risk.

Therefore, in the case where the relative state detecting unit 13 has detected, as the relative state, traveling directions of the host vehicle and another vehicle or a pedestrian and a relative speed and a relative distance of the host vehicle with respect to the other vehicle or the pedestrian, the information presenting unit 14 and the motion control unit 15 calculate the risk from the traveling directions, the relative speed, and the relative distance.

The degree of risk increases as the relative distance decreases, and the degree of risk decreases as the relative distance increases. Note that in the case where the traveling directions are opposite to each other, the risk increases even when the relative distance is great, while in the case where the traveling directions are the same, the risk decreases even when the relative distance is short.

Moreover, the degree of risk increases as the relative speed is increased, and the degree of risk decreases as the relative speed is reduced.

The information presenting unit 14 displays pre-notification information indicating that the opening angle of the door is narrower as the calculated risk is larger and displays pre-notification information indicating that the opening angle of the door is wider as the calculated risk is smaller.

The motion control unit 15 narrows the allowable opening angle of the door as the calculated risk is larger and widens the allowable opening angle of the door as the calculated risk is smaller.

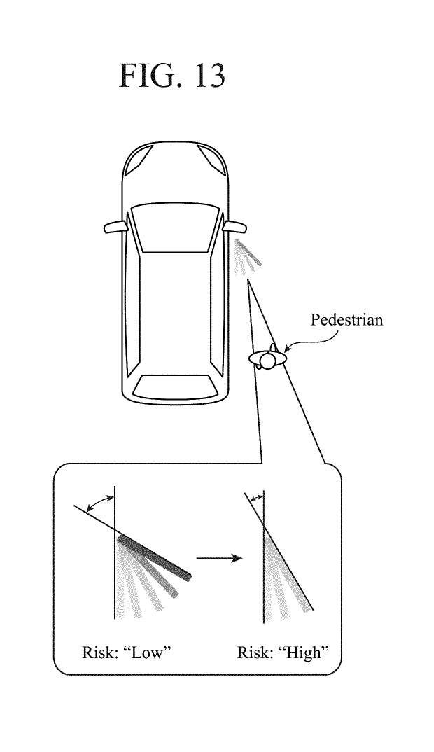

FIG. 13 is an explanatory diagram illustrating an example of pre-notification information corresponding to a relative state.

FIG. 13 illustrates examples of pre-notification information in the case where the opening angle of a door is narrow because the risk of “door opening operation” is high and pre-notification information in the case where the opening angle of the door is wide because the risk of “door opening operation” is low.

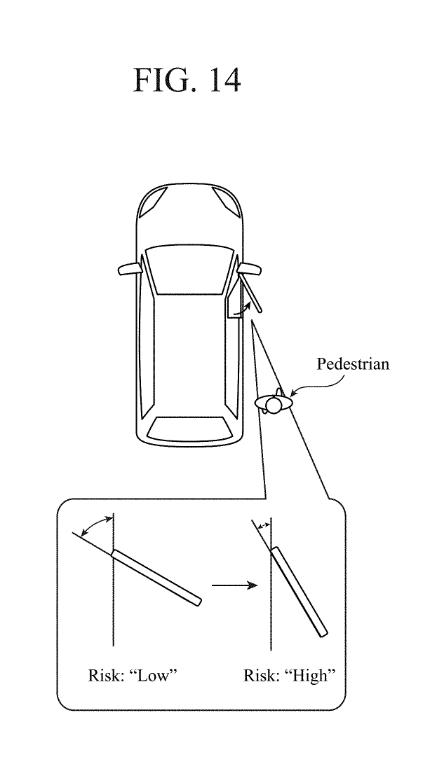

FIG. 14 is an explanatory diagram illustrating an example of motion control corresponding to a relative state.

FIG. 14 illustrates an example in which the opening angle of a door is limited to be narrow by the motion control unit 15 since the risk of “door opening operation” is high and an example in which the opening angle of the door is allowed to be wide by the motion control unit 15 since the risk of “door opening operation” is low.

Here, the pre-notification information and control of the motion accompanying an operation in the case where the operation on the vehicle is “door opening operation” have been described; however, in the case where the operation on the vehicle is the “turning right/left operation” for example, display data as illustrated in FIG. 5B is conceivable, while in the case where an operation on the vehicle is “starting operation”, the display data as illustrated in FIG. 5C is conceivable. Meanwhile, for example, as the position where another vehicle or a pedestrian is present is closer to the host vehicle, the risk of the “turning right/left operation” or the “starting operation” is high. Also, the risk is higher as the “turning right/left operation” or the “starting operation” is sudden.

Therefore, in the case where an operation on the vehicle is “turning right/left operation”, the information presenting unit 14 displays pre-notification information indicating a simulated figure of a big indicator to call attention as the calculated risk is larger.

Alternatively, in the case where an operation on the vehicle is “starting operation”, the information presenting unit 14 displays pre-notification information indicating a big simulated figure of a traveling direction to call attention as the calculated risk is larger.

In the case where an operation on the vehicle is “turning right/left operation” or “starting operation”, the motion control unit 15 extends time to restrict the motion of a drive system or other systems of the vehicle as the calculated risk is larger. Alternatively, control is performed such that the traveling speed of the vehicle is reduced as the calculated risk is larger.

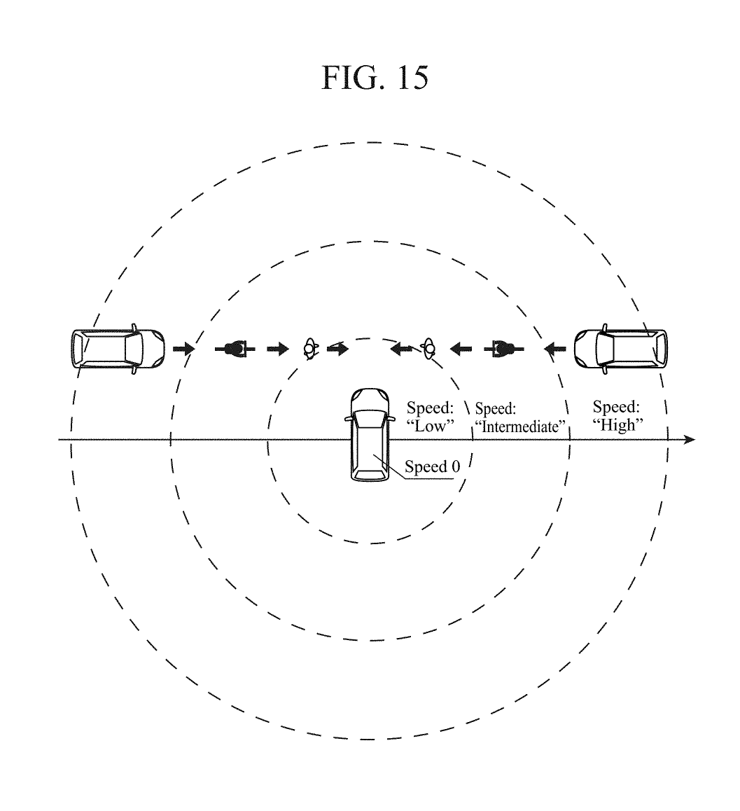

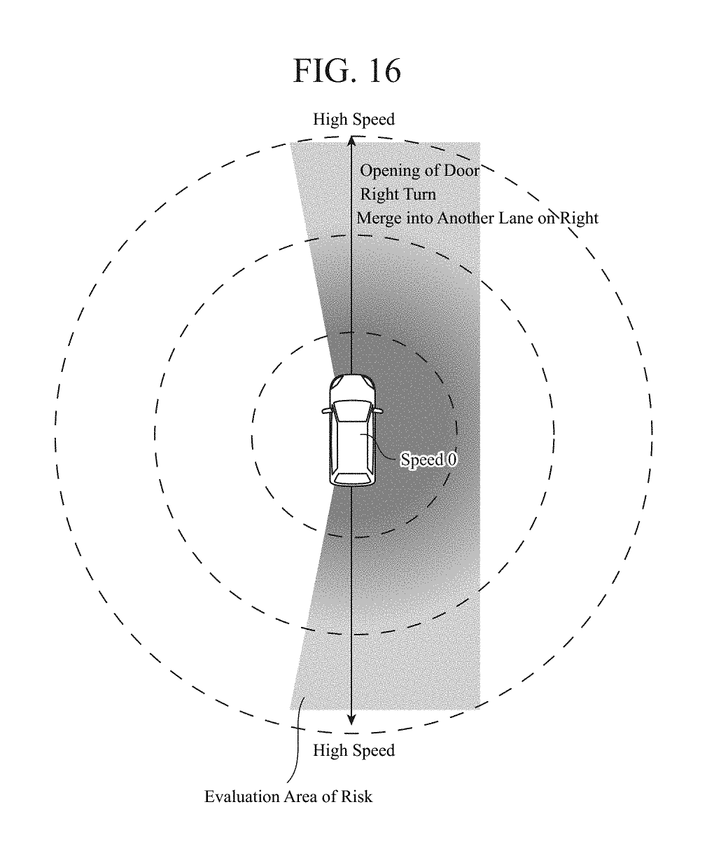

FIGS. 15 and 16 are explanatory diagrams each illustrating a relationship between risk and relative states.

FIGS. 15 and 16 illustrate that the closer the relative distance which is the relative state is, the higher the risk is.

In the example of FIG. 15, the host vehicle is located at the center of concentric circles, and pedestrians, two-wheeled vehicles, and passenger cars are present around the host vehicle.

The example of FIG. 15 illustrates that, if traveling speeds of the pedestrians, the two-wheeled vehicles, and the passenger cars with respect to the host vehicle are the same, the risk of the pedestrians present at the position closest to the host vehicle is the highest, the risk of the two-wheeled vehicles present at the next closest position is the second highest, and the risk of the passenger cars present at the farthest position is the lowest.

However, if pedestrians<two-wheeled vehicles<passenger cars holds in terms of the traveling speed with respect to the host vehicle, even with the positional relationship as illustrated in FIG. 15, the risk of the pedestrians, the two-wheeled vehicles, and the passenger cars may be approximately the same, or the risk of passenger cars may be the highest.

FIG. 16 is a diagram corresponding to the case where an operation on the vehicle is “door opening operation” and “starting operation” and illustrating that the front side, the front right side, the right side, the rear right side, and the rear side of the host vehicle are included in an evaluation area of the risk.

As is apparent from the above description, according to the third embodiment, the relative state detecting unit 13 for detecting a relative state with another vehicle or a pedestrian is included, and the information presenting unit 14 presents pre-notification information corresponding to the relative state detected by the relative state detecting unit 13, thereby achieving an effect that pre-notification information suitable for the risk can be presented.

Furthermore, according to the third embodiment, the relative state detecting unit 13 for detecting a relative state with another vehicle or a pedestrian is included, and the motion control unit 15 controls the motion accompanying the operation detected by the operation detecting unit 1 depending on the relative state detected by the relative state detecting unit 13, thereby achieving an effect that an accuracy of preventing occurrence of a dangerous situation can be improved as compared to the first and the second embodiments described above.

In the third embodiment, the example in which the vehicle control device mounts the information presenting unit 14 and the motion control unit 15 has been illustrated; however, instead of the information presenting unit 14, the information presenting unit 7 of the first embodiment or the information presenting unit 11 of the second embodiment may be mounted.

Note that, within the scope of the present invention, the present invention may include a flexible combination of the respective embodiments, a modification of any component of the respective embodiments, or an omission of any component in the respective embodiments.

### INDUSTRIAL APPLICABILITY

A vehicle control device and a vehicle control method according to the present invention are suitable for use of controlling the motion of a vehicle.

### REFERENCE SIGNS LIST

1: Operation detecting unit, 2: Vehicle information acquiring unit, 3: Operation detection processing unit, 4: Display data outputting unit, 5: Display data storing unit, 6: Display data selecting unit, 7: Information presenting unit, 7a: Light emitting unit, 8: Motion control unit, 9: Situation notifying unit, 10: Presence determining unit, 11: Information presenting unit, 11a: Light emitting unit, 12: Motion control unit, 13: Relative state detecting unit, 14: Information presenting unit, 14a: Light emitting unit, 15: Motion control unit, 21: Vehicle information acquiring circuit, 22: Operation detection processing circuit, 23: Display data storage processing circuit, 24: Display data selection processing circuit, 25: Information presentation processing circuit, 26: Motion control processing circuit, 27: Situation notification processing circuit, 28: Presence determination processing circuit, 29: Information presentation processing circuit, 30: Motion control processing circuit, 31: Relative state detection processing circuit, 32: Information presentation processing circuit, 33: Motion control processing circuit, 41: Memory, 42: Processor.

1-9. (canceled)

10. A vehicle control device, comprising:
a memory; and
a processor coupled to the memory, the processor being configured to execute an application stored in the memory to perform a process configured to,
to detect an operation on a vehicle;
to present pre-notification information for pre-notifying motion accompanying the detected operation to an outside of the vehicle; and
to control the motion accompanying the detected operation.

11. The vehicle control device according to claim 10,
wherein the processor restricts the motion accompanying the detected operation until a certain period of time elapses after the processor has detected the operation on the vehicle.

12. The vehicle control device according to claim 10,
wherein the process is further configured to:
to determine whether another vehicle or a pedestrian is present around the vehicle,
wherein when the processor determines that another vehicle or a pedestrian is present, the processor restricts the motion accompanying the detected operation and, when the processor determines that no other vehicle or pedestrian is present, the processor allows the motion accompanying the detected operation.

13. The vehicle control device according to claim 10,
wherein the process is further configured to:
to determine whether another vehicle or a pedestrian is present around the vehicle,
wherein when the processor determines that another vehicle or a pedestrian is present, the processor presents the pre-notification information to the outside of the vehicle and, when the processor determines that no other vehicle or pedestrian is present, the processor stops presenting the pre-notification information.

14. The vehicle control device according to claim 13,
wherein the processor presents caution information for calling attention to the outside of the vehicle regardless of the determination result.

15. The vehicle control device according to claim 12,
wherein the process is further configured to:
to detect, when the processor determines that another vehicle or a pedestrian is present, a relative state with respect to said another vehicle or said pedestrian,
wherein the processor controls the motion accompanying the detected operation in accordance with the detected relative state.

16. The vehicle control device according to claim 13,
wherein the process is further configured to:
to detect, when the processor determines that another vehicle or a pedestrian is present, a relative state with said another vehicle or said pedestrian,
wherein the processor presents pre-notification information in accordance with the detected relative state.

17. The vehicle control device according to claim 10,
wherein the process is further configured to:
to notify a situation in which the motion is controlled.

18. A vehicle control method, comprising:
detecting, by an operation detecting unit, an operation on a vehicle;
presenting, by an information presenting unit, pre-notification information for pre-notifying motion accompanying the operation detected by the operation detecting unit to an outside of the vehicle; and
controlling, by a motion control unit, the motion accompanying the operation detected by the operation detecting unit.
